(19) United States
(12) Patent Application Publication
(10) Pub. No.: US 2007/0143361 A1
(43) Pub. Date: Jun. 21, 2007

(54) Image processing program, image processing method, image processing device, and image processing system

(75) Inventors: Toshiaki Arai, Kanagawa (JP); Masafumi Ono, Kanagawa (JP); Kazuko Kirihara, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/477,496

(22) Filed: Jun. 30, 2006

(30) Foreign Application Priority Data
Dec. 13, 2005 (JP) 2005-359208

(51) Int. Cl. G06F 17/30

(52) U.S. Cl. 707/202

(57) ABSTRACT

A storage medium readable by a computer, the storage medium storing a program of instructions executable by the computer to perform a function for processing an image, the function includes: executing a job; creating a log image from an image handled in the job and accumulating the log image; transferring the accumulated log image to an external device; setting a transfer guarantee level of the log image to the external device; and controlling whether to execute a job or to transfer the log image, in accordance with the set transfer guarantee level.

### BACKGROUND

1. Technical Field

The present invention relates to job log control for controlling an executed job such as copying, printing, scanning, or faxing as a job log (executive logging of a job), and in particular to an image processing program, an image processing method, an image processing device, and an image processing system each having an image logging function for creating an log image from an image handled by a job and transferring the log image to an external device.

2. Related Art

A printing system including plural clients and a printer connected to a local area network (LAN) and allowing plural users to use the printer in common has been known to the public.

In this printing system, print data of a document to be printed out is generated by the client, and can be printed out by sending it to the printer shared on the network. After the printing is performed by the printer, a job log of the print job is accumulated in the printer. The job log includes, for example, a job ID, a job type, job acceptance time, job finish time, job status (the state of a job), and so on.

### SUMMARY

According to an aspect of the present invention, a storage medium readable by a computer, the storage medium storing a program of instructions executable by the computer to perform a function for processing an image, the function includes: executing a job; creating a log image from an image handled in the job and accumulating the log image; transferring the accumulated log image to an external device; setting a transfer guarantee level of the log image to the external device; and controlling whether to execute a job or to transfer the log image, in accordance with the set transfer guarantee level.

### BRIEF DESCRIPTION OF THE DRAWINGS

Embodiments of the present invention will be described in detail based on the following figures, wherein:

FIG. 1 is a diagram for showing an image processing system according to an embodiment of the invention;

FIG. 2 is a block diagram of a multifunction device according to an embodiment of the invention;

FIG. 3 is a block diagram of a job log control server according to an embodiment of the invention; and

FIG. 4 is a flowchart for explaining the operation of a multifunction device according to an embodiment of the invention.

### DETAILED DESCRIPTION OF THE INVENTION

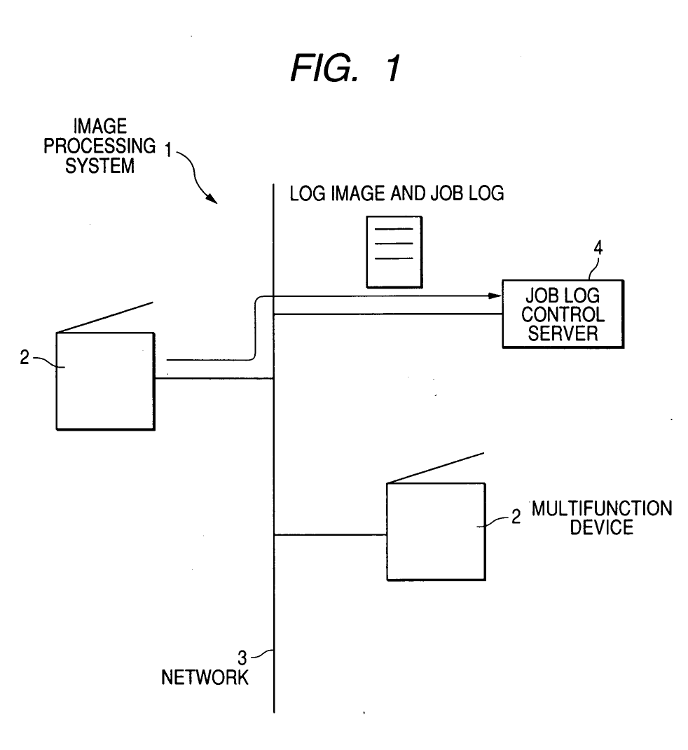

FIG. 1 shows an image processing system according to an embodiment of the invention. The image processing system 1 is provided with plural multifunction devices 2, as image processing devices, each having an image logging function for generating a job log in accordance with execution of the job, creating a log image from the image handled by the job, and transferring the log image to an external device, and a job log control server 4 for storing the job log and the log image transferred from each of the multifunction devices 2 via a network 3 as a communication medium. To the network 3, one or more of user terminals (not shown) each composed of a personal computer (PC) can be connected.

The image processing device includes a single function device such as a copy machine, a printer, a scanner, a facsimile machine, and so on, a multifunction device including functions of copying, printing, scanning, faxing, and so on, and a system having a copy machine, a printer, a scanner, a facsimile machine, and so on.

The image logging function includes, the function of generating a job log and a log image and transferring them to the job log control server 4, and a function of accumulating the log image in the multifunction device 2 in association with the job log and a function of accumulating the job log and the log image in the job log control server 4 associated with each other. The log image is created from the image handled by the job, and includes, for example, a reduced image, an image of a selected page, and an image of all pages.

The job includes not only a single job but also a job flow having plural jobs. Since a common image is used by the plural jobs in the job flow, the log image is created from the common image. An image being used by the job or an image after use of the job is included in “an image handled in the job.”

The external device includes a control server for controlling one or more of image processing devices, an external storage device, and so on.

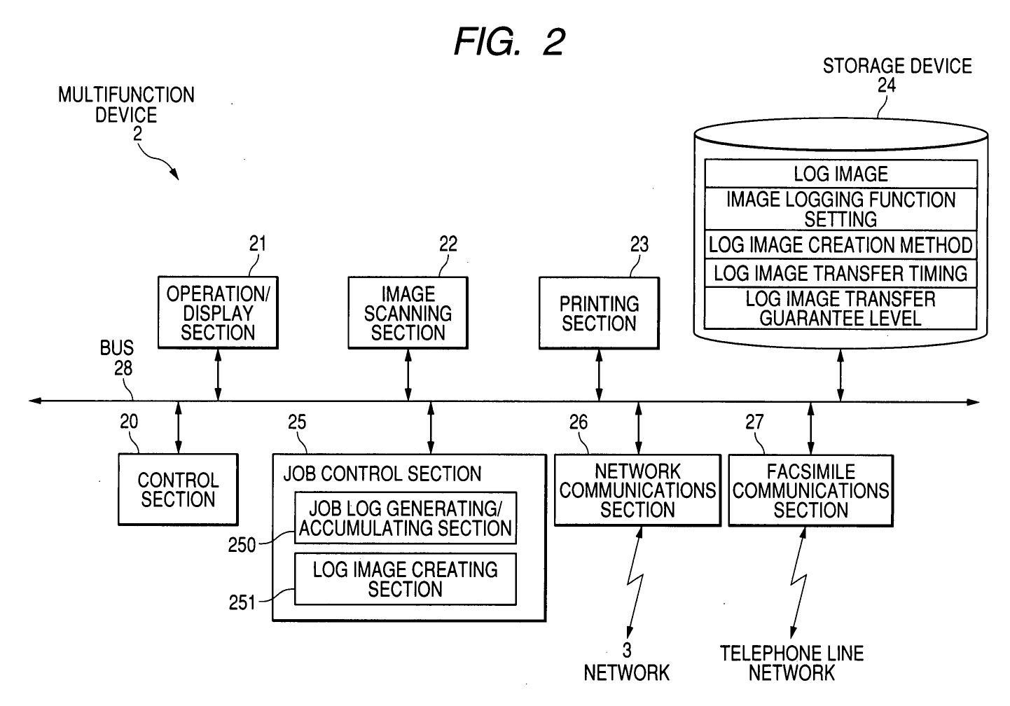

FIG. 2 is a block diagram of the multifunction device 2. The multifunction device 2 includes a control section 20 equipped with a CPU, a ROM, a RAM, and soon, and for controlling every section of the multifunction device 2, an operation/display section 21 provided with a touch panel display composed of a display and a touch panel stacked on the surface of the display and a hard key such as a start key, an image scanning section 22 for optically scanning a document to read out the image, a printing section 23 for printing an image on a sheet by, for example, an electrophotographic method, a storage device 24 composed of an HDD and so on for storing various information such as a setting screen, setting information or images, a job control section 25 for issuing a job ID in response to acceptance of a job and generating a job log and so on after the job has been executed, a network communications section 26 connected to the network 3, and a facsimile communications section 27 connected to the telephone line network or the like, all connected to each other via a bus 28.

The multifunction device 2 has plural functions such as copying, printing, scanning, faxing, and e-mailing. A job processes an image using one or more of these functions. A job is accepted by the operation/display section 21, or can be accepted from a user terminal (not shown), which is connected to the network 3 and includes a PC.

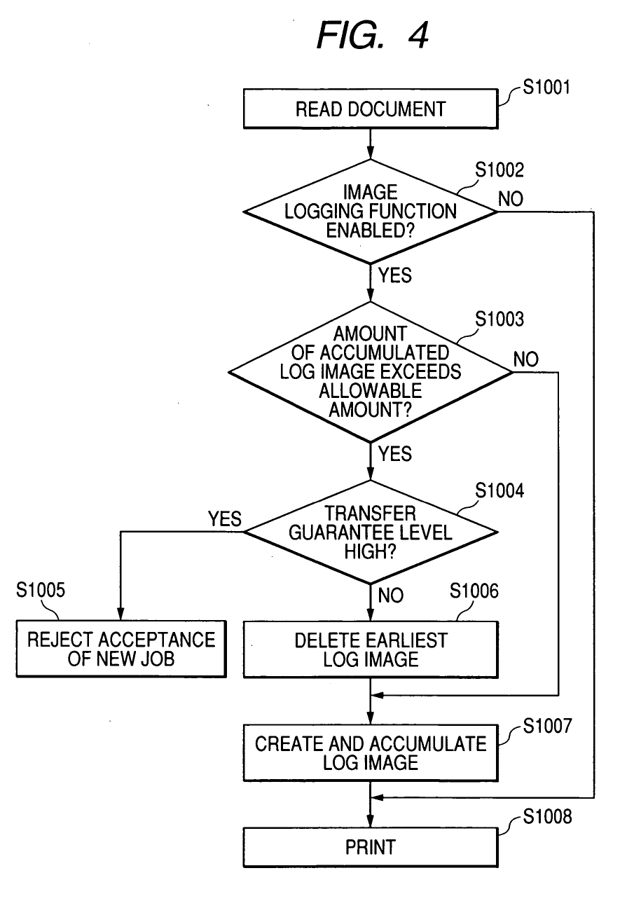

In the ROM of the control section 20 or the storage device 24, there are stored various programs such as a job execution program and an image processing program shown in a flowchart of FIG. 4 described later. And, the CPU of the control section 20 controls every section of the multifunction device 2 in accordance with the program stored in the ROM or the storage device 24.

The job control section 25 includes a job log generating/accumulating section 250 for generating the job log after the job has been executed and accumulating the job log, and a log image creating section 251 for creating a log image from the image handled in the job. The job control section 25 operates under the control of the CPU of the control section 20 to accumulate the log image created by the log image creating section 251 in the storage device 24 in conjunction with the multifunction device ID and the job ID.

The job log includes, for example, the multifunction device ID, the job ID, the job type, a user name, the job acceptance time, the job finish time, and the job status information such as waiting, processing, suspended, completed, the number of printed pages, the type of error and so on.

The log image creating section 251 executes the process on the image handled by the job in accordance with the log image creating method stored in the storage device 24 to create the log image. As the log image creating method, for example, a method of lowering the resolution of the image or a method of selecting a page used as the log image may be cited.

The storage device 24 also stores image logging function setting information set by the administrator, the log image creating method, log image transfer timing information, a log image transfer guarantee level, and soon besides the log images described above.

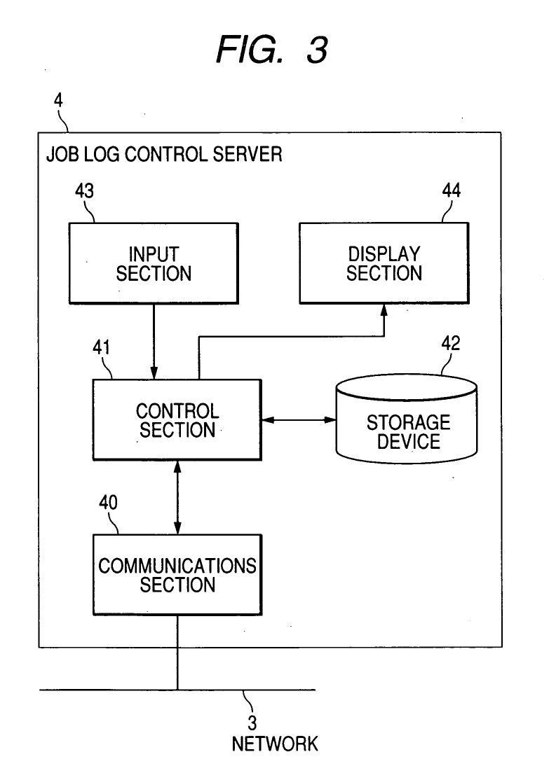

FIG. 3 is a block diagram of the job log control server 4. The job log control server 4 includes a communications section 40 connected to the network 3, a control section 41 equipped with a CPU, a ROM, a RAM, and soon, and for controlling every section of this server 4, a storage device 42 composed of an HDD and soon, an input section 43 provided with a keyboard, a mouse, and so on, and a display section 44 composed of an LCD or the like and for displaying a setting screen and so on.

In the ROM of the control section 41 or the storage device 42, there are stored various kinds of programs, and the CPU of the control section 41 controls every section of the job log control server 4 in accordance with the program stored in the ROM or the storage device 42.

The storage device 42 is for storing the log images and job logs transferred from each of the multifunction devices 2, the setting screen and so on, and the log images are stored associated with the respective job logs.

### OPERATION OF THE PRESENT EMBODIMENT

The operation of the present embodiment will now be explained dividing into cases.

1. Administrator Setting Mode

The administrator of either of the system 1 or the multifunction device 2 inputs the password by operating the operation/display section 21 of the multifunction device 2, and when the administrator is identified as the true administrator, the mode is switched to the administrator setting mode. The administrator makes the operation/display section 21 display the image logging function setting screen by selecting the “image logging function setting” button from the menu screen.

If the administrator sets the image logging function to “ON” (enabled) or “OFF” (disabled) by selecting either one of them on the image logging function setting screen, the control section 20 stores the image logging function setting information in the storage device 24.

After selecting the image logging function “ON,” the administrator then makes the operation/display section 21 display the log image creation setting screen. And, when the administrator sets the log image creation method and the log image transfer timing by selecting one from plural alternatives on the log image creation setting screen, and also sets the log image transfer guarantee level by selecting either one of “HIGH” and “LOW” on the log image creation setting screen, the control section 20 stores the setting information in the storage device 24. After storing the information, the mode is switched from the administrator setting mode to the normal mode. It is assumed here that nighttime is selected as the log image transfer timing out of the plural alternatives of power-on, job termination, nighttime, and so on.

2. Normal Mode

FIG. 4 is a flowchart of the multifunction device 2 in the normal mode. FIG. 4 shows the case in which copying is selected as the job, for example.

The user sets the document on a document bed (not shown) or an automatic document feeder (ADF), selects copying as the job from the main menu, sets the detailed settings for the copy job such as the sheet size or the number of copies by operating the operation/display section 21 of the multifunction device 2, and pushes the start key of the operation/display section 21 to make the image scanning section 22 read the document (step S1001).

When the scanning of the document is started, the job control section 25 issues the multifunction device ID and the job ID, and controls the copy job based on the multifunction device ID and the job ID.

The control section 20 stores the document image, which has been read out from the document by the image scanning section 22, in the storage device 24.

The control section 20 judges whether or not the image logging function is enabled in accordance with the image logging function setting information stored in the storage device 24 (step S1002).

If the image logging function is set to “ON” (enabled) (YES in step S1002), whether or not an amount of accumulated log images, which have not been finished to be transferred to the storage device 24, exceeds an allowable amount (step S1003).

If the amount of accumulated log images, which have not been finished to be transferred to the external device, exceeds the allowable amount (YES in step S1003), whether or not the log image transfer guarantee level is set to “HIGH” based on the log image transfer guarantee level stored in the storage device 24 (step S1004).

If the log image transfer guarantee level is set to “HIGH” (YES in step S1004), the acceptance of the present new jobs is rejected (step S1005).

If, in the step S1004, the log image transfer guarantee level is set to “LOW” (NO in step S1004), the earliest created one of the log images presently accumulated in the storage device 24 is deleted (step S1006).

And, the log image creating section 251 of the job control section 25 executes the image processing process on the image handled by the new job in accordance with the method of creating log image stored in the storage device 24 to create the log image. The job control section 25 accumulates the log image thus created in the storage device 24 in association with the job log (step S1007).

The control section 20 reads out the document image from the storage device 24, and outputs it to the printing section 23. The printing section 23 prints the document image on paper and outputs the paper (step S1008).

If, in the step S1003, the amount of accumulated log images does not exceed the allowable amount (NO in step S1003), printing is performed (step S1008) after creating and accumulating the log image for the present new job (step S1007) without performing deletion of the existing log images (step S1006). The job log generating/accumulating section 250 of the job control section 25 generates and then accumulates the job log after the job has been executed.

If the image logging function is set to “OFF” (disabled) in the step S1002 (NO in step S1002), the printing is performed (step S1008) without performing the creation of the log image (step S1007).

3. Transfer of Job Log and Log Image

In nighttime, when job log is transferred, the control section 20 detects it and transfers the log images accumulated in the storage device 24 with the job logs accumulated in the job log generating/accumulating section 250 to the job log control server 4 in a lump via the network communications section 26 and the network 3. The control section 41 of the job log control server 4 receives the job logs and the log images transferred from the multifunction device 2 by the communications section 40, and stores the job logs and the log images in the storage device 42 so that the log images are associated with the respective job logs.

The job logs and the log images can be stored so as to be associated with each other, by, for example, storing each of the job logs and the log images associated with the multifunction device ID and the job ID. The job logs and the log images are provided to the administrator for controlling the jobs.

### OTHER EMBODIMENTS

Note that the invention is not limited to the embodiments described above, but may be put into practice in variously modified forms within the scope or the spirit of the invention.

For example, the image input may be provided, besides by reading out the document with a device, by inputting from the client, by reading via facsimile communication from the outside, or by reading from a scanner or the like connected to the device.

It is also possible that, by making the image scanning section optically read an instruction form on which content of job or a condition for creating the log image is written, and the log image creating section creates the log image based on the instruction.

Although the job logs and the log images are stored in the control server in the embodiment described above, they may be stored in the multifunction devices or other external storage devices instead of the control server. Still further, the job logs and the log images may be stored in respective devices different from each other.

It may be possible to create a thumbnail image composed of plural log images. Thus, the contents of the log images may quickly be figured out and confirmed.

Although the ON/OFF setting of the image logging function and the log image transfer guarantee level are set by the administrator in the embodiment described above, either one or both of them may be set by the user. Thus, the user may select which one of the viewpoint of security or the viewpoint of performance should be given priority. For example, the user can set the image logging function to “OFF” if the user wants to temporarily give priority to the job processing performance over the security.

The entire disclosure of Japanese Patent Application No. 2005-359208 filed on Dec. 13, 2005 including specification, claims, drawings and abstract is incorporated herein by reference in its entirety.

What is claimed is:

1. A storage medium readable by a computer, the storage medium storing a program of instructions executable by the computer to perform a function for processing an image, the function comprising:
executing a job;
creating a log image from an image handled in the job and accumulating the log image;
transferring the accumulated log image to an external device;
setting a transfer guarantee level of the log image to the external device; and
controlling whether to execute a job or to transfer the log image, in accordance with the set transfer guarantee level.

2. The function for processing the image according to claim 1, further comprising:
setting ON/OFF of an image logging function, wherein
the creating of the log image, the transferring of the log image, the setting the transfer guarantee level, and the controlling are enabled when the image logging function is set to ON.

3. The function for processing the image according to claim 1, wherein
when the transfer guarantee level is set to a high level, an acceptance of a new job is rejected if an amount of the accumulated log image exceeds a predetermined amount, the log image has not been transferred to the external device.

4. The function for processing the image according to claim 1, wherein
if the transfer guarantee level is set to a low level, the accumulated log image is deleted when a new job is accepted, if an amount of the accumulated log image exceeds a predetermined amount.

5. The function for processing the image according to claim 1, further comprising:
generating and accumulating a job log after the execution of the job, wherein
the log image is accumulated in association with the job log.

6. An image processing method comprising:
executing a job;
creating a log image from an image handled in the job and accumulating the log image;
transferring the accumulated log image to an external device;
setting a transfer guarantee level of the log image to the external device; and
controlling whether to execute a job or to transfer the log image, in accordance with the set transfer guarantee level.

7. The image processing method according to claim 6, further comprising:
setting ON/OFF of an image logging function, wherein
the creating of the log image, the transferring of the log image, the setting the transfer guarantee level, and the controlling are enabled when the image logging function is set to ON.

8. The image processing method according to claim 6, wherein
when the transfer guarantee level is set to a high level, an acceptance of a new job is rejected if an amount of the accumulated log image exceeds a predetermined amount, the log image has not been transferred to the external device.

9. The image processing method according to claim 6, wherein
if the transfer guarantee level is set to a low level, the accumulated log image is deleted when a new job is accepted, if an amount of the accumulated log image exceeds a predetermined amount.

10. The image processing method according to claim 6, further comprising:
generating and accumulating a job log after the execution of the job, wherein
the log image is accumulated in association with the job log.

11. An image processing device comprising:
an execution unit that executes a job;
a creation unit that creates a log image from an image handled in the job and accumulates the log image;
a transfer unit that transfers the accumulated log image to an external device;
a setting unit that sets a transfer guarantee level of the log image to the external device; and
a control unit that controls whether to execute a job or to transfer the log image in accordance with the set transfer guarantee level set by the setting unit.

12. The image processing device according to claim 11, further comprising:
an image logging function setting unit that sets ON/OFF of an image logging function, wherein
the creation unit, the transfer unit, the setting unit and the control unit are enabled when the image logging function is set to ON.

13. The image processing device according to claim 11, wherein
when the transfer guarantee level is set to a high level, an acceptance of a new job is rejected if an amount of the accumulated log image exceeds a predetermined amount, the log image has not been transferred to the external device.

14. The image processing device according to claim 11, wherein
if the transfer guarantee level is set to a low level, the accumulated log image is deleted when a new job is accepted, if an amount of the accumulated log image exceeds a predetermined amount.

15. The image processing device according to claim 11, further comprising:
a generation unit that generates and accumulates a job log after the execution of the job, wherein
the log image is accumulated in association with the job log.

16. An image processing system comprising:
an image processing device that executes a job; and
a control server connected to the image processing device via a communication medium, wherein
the image processing device includes:
an execution unit that executes the job;
a generation unit that generates and accumulates a job log after executing the job;
a creation unit that creates a log image from an image handled in the job and accumulates the log image;
a transfer unit that transfers the accumulated job log and the accumulated log image to an external device;
a setting unit that sets a transfer guarantee level of the log image to the external device; and
a control unit that controls whether to execute a job, or to transfer the job log or the log image, in accordance with the transfer guarantee level set by the setting unit, and
the control server includes:
a storage unit that stores the job log and the log image transferred from the transfer unit in association with each other.
